(19) United States
(12) Patent Application Publication
(10) Pub. No.: US 2009/0319415 A1
(43) Pub. Date: Dec. 24, 2009

(54) Momentary Power Market

(76) Inventors: Georgi Dimov Stoilov, Sofia (BG); Dimo Georgiev Stoilov, Sofia (BG); Luben Georgiev Stoilov, Sofia (BG)

Correspondence Address: Luben Stollov, 100 Marin Center Dr., #24, San Rafael, CA, 94903, US

(21) Appl. No.: 11/887,810

(22) PCT Filed: Dec. 2, 2004
(86) PCT No.: PCT/BG2004/000023

§ 371 Date: Jan. 16, 2009

(30) Foreign Application Priority Data
Aug. 23, 2004 (BG) 108851

(51) Int. Cl. G06Q 40/00; G06Q 50/00

(52) U.S. Cl. 705/37

(57) ABSTRACT

A method and system is proposed for the physical trading of electricity, which is characterized by continuous Dynamic Advanced Prices formation and propagation over a single price period that is a few seconds long. The Node and Branch price equations are applied to the power flows and to the corresponding costs incurred at measure points, as well as to the system-wide costs allocated equitably by means of a Price Designator, Price Announcers, Price Transmuters and Intelligent Meters and by other devices, all of which function together in a sequential and repetitive process of preliminary bidding, clearing, adjustment and dispatching, followed by price designation, confirmation and conversion in a way that takes into account congestion and security costs and the compensation of involuntary deviations. The method provides a common electricity trade environment that allows every market participant, especially every consumer, to respond adequately to last minute price changes.

### DESCRIPTION OF INVENTION

1. Technical Field

The present invention relates to a deregulated Electricity Market for the trading of physical electricity. The invention further relates to any electricity system for power supply without limitation of size, physical structure, type of ownership or other parameters. In particular, the invention pertains to the integration in infrastructure and operation of the Power Market environment and of power systems.

2. Background Art

The modern Electric Power Systems (EPSs)/Grids integrate multiple generation Units with a large number of Consumers by transmission and distribution facilities in order to supply users with electric energy whenever they need it. The EPSs operate interconnected in a framework of many statewide or regional control areas/blocks and often across continental borders.

Starting with Argentina, many countries have begun to reorganize the classic utility-based organization of EPSs. Usually this process is called deregulation or liberalization. Its aim is to bring competition into the power supply sector and thus to reduce the prices that end users pay.

In the USA, the deregulation process is subject to Energy Policy Act of 1992 and to FERC orders 888 and 889 from 1996, and 2000 from 1999. These orders address first of all the wholesale Electricity Market. The FERC White Paper (Apr. 28, 2003) mentions some profound problems facing free market implementation to the end Consumers.

In Europe the process of liberalization is based on The Energy Charter Treaty and Directives 96/92/EC and 54/2003/EC of the European Parliament and of the European Council, and on Regulation (EC) No 1228/2003 of the European Parliament and of the European Council.

In the rest of the world the deregulation process is similar.

Because of EPS reorganization, many market designs have appeared and have passed through the early stages of maturity. Financial markets intertwine with bilateral and multilateral physical markets (public, common agreements). At least four physical markets complement each other in time: week-ahead, day-ahead, hour-ahead and real-time (balancing) markets. The Commodities traded there are power, ancillary and System Services (A&SSs), generation capacity or its availability, and transfer capacity or rights of using such capacity. Bidding and scheduling are provided either by the Power Exchange (PX) or the Pool or System Operator (ISO, RTO, etc.).

The rules for price clearing and settlement in today's market are very complicated.

Next in complexity is the management of network congestion chiefly because of the lack of tools for actual power path pricing.

The most complex problem is that of ensuring quality and stability where both the Electric Power System reliability and the real time market viability are concerned. To solve this problem is the task of both the ancillary and the balancing markets (some authors use the term ‘regulating market’). These markets allow the System Operator to keep the System in balance and to control power flows across the grid. The balancing market decisions are the subject of continual disputes because of the impossibility of distinguishing between Ancillary Services and balancing power produced by the same sources (Units).

All this complexity of market design and its rules entails a lack of price formation transparency. This awkwardness of implementation is at the root of the limited spread of such markets despite the best wishes of all those involved.

One of the main reasons for the above difficulties of existing Power Markets is that price 55 setting and clearing is separated in time and place from the generation, transmission, distribution and consumption of electricity.

The shortest known Balance power Single price interval/period is five minutes. Prices fixed over intervals so long cannot be used as an accurate balancing tool in rapidly changing environment in real EPS.

The retail prices paid by end power users do not reflect the changes at the level of wholesale clearing prices (at spot or real time market). As a result, the reaction of end Consumers is not adequate even when drastic generation or network changes occurred. A partial exemption from the prevalent situation described above is the control of the so cold price sensitive or interruptible loads. Therefore in the present state of the energy markets retail prices cannot serve as generally applicable market and physical regulator for power systems real time control.

Theoretical way of avoiding some of the enumerated shortcomings of today's' Electricity Markets is offered by theory of nodal real time prices, developed in [1]-[9]. Up to now the implementation of the theory have been based on increasingly complicated EPS' models in order to reflect ever more numerous real constraints. The increasing computational complexity makes the problem practically intractable. (“The software, hardware, manpower, and computational requirements . . . are formidable”[5]).

At the same time it is well known ([5]) that it is impossible to implement advanced nodal real time prices that permanently and adequately reflect the frequent changes in EPS constrains with out allowing reasonable flexibility in the satisfaction of requirements.

Therefore the approach of modelling all dynamic constraints is not satisfactory.

Because of these we suggest at the beginning to start implementation with the main advanced nodal price components by making them and the basic payment for electricity functions of a single parameter: active power. These price components have to be formed as shortly as possible (no longer then a few seconds) before the moment of power utilization. They have to be updated continually according to the actual operational conditions in entire EPS. We call these prices Dynamic Advanced Prices (DAP). Technical possibilities for the implementation of such prices can be available at reasonable costs.

The aim of this invention is to overcome the above-mentioned limitations inherent in today's market models. We suggest alternative approach to Electricity Market development by means of simplifying and decentralizing the formations and conversions and propagation of prices.

The approach is based on the inherent communication and information properties and potential of the existing power systems. It is described bellow followed by the novelties explained in the Claims.

### DISCLOSURE OF THE INVENTION

### Technical Essence

We call the proposed method and system for the free physical trade of electric power a ‘Momentary Power Market’. This market unifies the whole sale with retail Markets and combines the sale of electricity according to bilateral and multilateral agreements with the market of Ancillary Services, as well as with an eqitable allocation of system-wide expenses for the obligatory services of the system operator and the transmission and distribution operators, in a manner proportionate to the use of these services by every market participant (an illustration of such a market is presented on FIG. 1). The hitherto known four markets subordinate to each other according to the time period covered, namely weekly, daily, hourly, and balancing markets, are replaced by a single market, where adjustment and balancing are the result of three concurrent activities: the preliminary adaptation to expected real-time conditions, the fixing of the trading price for the current time period, and the compensation of involuntary deviations that have occurred during this period (the basic actions of the principal market participants are presented in summary in the table in FIG. 2). On the basis of every Producer's freely determined bid for sale of electric power or Ancillary Services, a continually iterated process of selective preparation, formation, transmutation, and propagation of a price for every location where electric power or network components change ownership is proposed. This price corresponds to the cost of the power physically produced, transmitted, distributed, and delivered over a time period as short as possible (of the order of several seconds or minutes), called a ‘single-price period’, for the duration of which one assumes network conditions to be changeless. The price over the following single-price period includes a compensation term, calculated at every Unit, for the cost of two kinds of involuntary deviations over the preceding single-price period: (i) between power bilaterally contracted and power actually consumed, as in Equation (26) and (ii) between power dispatched and power actually provided by the Unit, as in Equation (27). Equations (3), (4), and (5) ensure the inclusion of compensation terms in the price.

In order to realize the proposed continual preparatory adaptation to the expected real-time condition and the subsequent selective formation, transmutation, and propagation of the actual price, automated procedures are proposed.

The first automated procedure for planning, committing, and dispatching of power gives a forecast fit based on every Producer's freely determined bid for sale of electric power and on forecast conditions in the EPS. At this stage, Units submit to the system operator their bids for prices and power amounts for every hour in the immediately following twenty-four-hour period, not for a single interval of fixed prices. The system operator arranges the preliminary hourly prices and commits the Units for expected hourly power amounts for twenty-four hours ahead. This stage of preliminary dispatching is very similar to the existing practices of a day-ahead and hour-ahead markets. The principal difference is that these markets are merged and the closing time is shifted every hour.

In the second automated procedure, which is applied at every Single Price Period, the system operator determines the price and the dispatched amount of power or Ancillary Services, within every Unit's operational limits, that are to be realized over the next Single Price Period, and notifies the Unit operator of every Unit. The Unit operator verifies that the goods demanded of him and their price are within the previously agreed range and, if so, sends a confirmation to the system operator and adjusts the Unit governor to the given settings. If the verification fails, the Unit operator adjusts the Unit to the nearest acceptable settings and notifies the system operator. At the same time, the Unit operator declares/announces the actual price and sends it, along with the values of the two kinds of involuntary deviations realized over the preceding period, to the Transmuter at the Node where the Unit is connected.

In order to realize the proposed Momentary Power Market, a special system of prices and of devices has been developed and is proposed. The price system is called ‘Dynamic Advanced Prices’. These are based on the monetary balance at every point of the network of the mandatory exchange of ownership of the power actually passing through the point. Applied to the Nodes and Branches of the network, this balancing requirement defines the so-called ‘Node Equation’ and ‘Branch Equation’ that the prices must satisfy. From these equations follow formulae (1)-(27) described below. These determine the prices in function of a single parameter, the active power at the corresponding point of the network. The formulae are applied to the corresponding power amounts, measured by commercially accepted means, to the amount of power produced by every Unit, to the values of involuntary deviations between power contracted and actually consumed, as well as between power dispatched and actually produced, to the cost of power delivered to the Inlets of every Node, to the cost of services provided by every owner of a Node or a Branch and to the cost of system-wide services (Ancillary Services, System Services, liquidated damages and allowances), as well as to the cost of automatically introduced fees for the overcoming of bottlenecks. These formulae are programmed into devices specially dedicated to this purpose, which selectively and in a decentralized manner execute the activities of the preparation, formation, transmutation, and propagation of the Dynamic Advanced Prices. Each of these programmable devices is named according to the most important of its functions described below: a Bidder, a Scheduler, a Price Designator, a price Announcer, a Price Transmuter, an Intelligent Electric Meter. Along with all conventional devices and other necessary computing or communication devices, these are installed at the control board of every Unit operator and of the system operator, at network Nodes and at Consumer Outlets (an illustration of the ordering of these devices in a single-line diagram of a power system is presented on FIG. 3). All devices function interdependently in a consecutive and uninterruptible process of bidding and adjusting the bids, preliminary dispatching and commitment, followed by the designation, verification, announcement, and propagation of prices and their repeated transmutation reflecting additional cost due to bottlenecks or security limitations as well as providing the required precision level of prices at every trading place in the general market system described (an illustration of the information flow in the main decentralized embodiment of the method of price formation and propagation is given on FIG. 4). This system allows every market participant and especially the final Consumers dynamically to control their market behavior according to the change of prices at every Single Price Period and to manage their adaptive strategy for control of power consumed or produced as well as of the corresponding monetary flow.

In order to make possible the application of Dynamic Advanced Prices, a ‘method for the equitable Allocation of the cost of system-wide expenses’ was specially developed and is here proposed. In accordance with this method, the value of all system-wide expenses for ancillary services purchased by the system operator, for liquidated damages and allowances to which the system operator is subject, as well as the cost of System Services provided by him, are divided equitably among all market participants on the basis of a presumptive Unit Node price obtained from the actual costs by using Formulae (4), (11), and (12). This Unit Node price is an auxiliary value based on the assumption that system-wide services apply to all Units and that each of them must pay a share proportionate to the power actually provided by every Unit, whose resulting expense is ultimately passed on to the final user as part of the Dynamic Advanced Prices. The Units are thus responsible for a proportionate part of every system-wide service: this equals the amount of power the Unit produces times the quotient of the total cost of the service and the amount of power produced in the system. In order to reflect actual network expenses, this presumptive price is subsequently transmuted according to Formulae (4), (11a), and (12a) by the Transmuter at every Node and thus become part of the Dynamic Advanced Prices that are propagated down every Branch concurrently with the power flow.

In order to make possible the application of Dynamic Advanced Prices, a ‘method for the trade in Ancillary Services’ was also developed and is here proposed. Its characteristic is that payments between Units and the system operator of the ancillary service market are based only on the availability price of the ancillary service, which is used for the approval of bids and for the calculation and allocation, according to the system of equations (11), of the total value of System Services committed by the operator. The Unit attaches a second price to services upon their activation. At this point, two cases are possible: (i) if the activation causes an increase in the amount of power provided by the Unit, the excessive power is paid for by its Recipients at the price of power from the corresponding Unit, and (ii) if the activation causes a dicrease in the amount of power provided by the Unit, the difference is subject to security expenses and liquidated damages paid to the Unit operator. These are calculated by the system operator and are divided among all participants as system-wide expenses according to equation (5).

Since the proposed Node and Branch Equations and the resulting applied formulae are a universal abstraction applicable to every network, the corresponding calculations can be realised by a series of variants of devices by which information flow and calculations are managed. One such alternative embodiment is presented on FIG. 5. It is characterised by the centralized, though still selective, execution of the two-stage procedure of continuous formation and transmutation of the dynamic advanced prices: the functions of the ‘Price Transmuter’ are taken over by the ‘Price Designator’, and the organization of information flows and the communication environment is changed accordingly from the main embodiment presented on FIG. 4.

Another embodiment is characterized by the division of the functions of the ‘Intelligent Electric Meters’ between two devices: a ‘Price Receiver’ and a conventional commercial electric meter.

Yet another embodiment is characterized by the substitution for the ‘Intelligent Electric Meters’ of a special ‘Commercial System of Telemeasurement and Integration of Momentary Power Flows’ in combination with a ‘Detection System for the State of the Network’.

Finally, a combined embodiment can be realized, which is characterized by the selective execution of the two-stage procedure of continuous formation, transmutation, and propagation of the Dynamic Advanced Prices by a heterogeneous combination of devices for centralized and decentralized transmutation and propagation, so that partial realizations of the preceding variants are realized within a common power system.

The briefly laid-out technical essence of the invention is made clearer by the definitions and clarifications of terms for elements, methods, systems, and devices.

Terms

In order to avoid any misunderstandings, we start with a short list of terms that could involve different meanings than usual or that obtain a specific meaning in this invention:
A Unit is a source of active electricity power generation whose output is subject to independent bids and can be scheduled, committed, dispatched, measured, sold and bought separately.
A Node is a junction bus, bus bar, distribution panel, collecting or distributing board, substation, etc.
A Branch of a grid is a network element connecting two network Nodes such as an OHV line, a cable, a transformer, a back-to-back station, an AC-to-DC converter, etc.
An Inlet is a Branch end through which power flows in the direction towards the Node. A Unit connection to a Node is treated as a separate case (an instance of Unit generation power flow, and this only when powers flows towards the Node).
An Outlet is a Branch end through which power flows in the direction away from the Node (a Branch connecting a Consumer to a Node is always an Outlet at the Node).
An Electricity Market, a Power Market, an Electric Energy Market, a Market design, a Market system and a Market environment are synonyms (some times with slightly different shades of meaning) that denote the legal, economic, institutional, and physical framework that makes possible the trade of electricity and related products (rights, capacity, power, ancillary or System Services etc.) between market participants and includes all elements: devices, applications, functional subordination, etc., necessary for its operation.
A Single Price Period (SPP) is determined as the shortest time interval between two consecutive moments of price formation and propagation. During this period, the network state is considered invariable. Hence, it has to be as short as possible, on the order of seconds. It can be uniform (e.g., equal to 10, 15, 30, or 60 seconds) or variable, e.g., re-started in the event of a disturbance (an instance of Branch or Unit tripping). A longer Single Price Period is inefficient. The Single Price Period resembles in the logic of its use the well-known hourly period in existing tariffs. For billing purposes, however, the hour could still be used as a unit period.
Ancillary Services (AS) are:
The provision of power reserves (in Europe, of—primary, secondary, tertiary, and cold reserves; in the USA, of—operating, regulating, AGC support, spinning, supplemental, and back-up reserves);
Reliability control services (voltage control, security control, FACTs control, relay protection etc.);
Black starts and network restoration services.

According to the provider the Ancillary Services can be classified in two groups: Unit's and Node's services.
System Services (SS) are:
Price clearing and Unit scheduling, commitment and preliminary dispatching;
Price designation;
The assessment and eqitable Allocation of system-wide expenses;
Automatic Generation Control (AGC);
Network monitoring and control, etc.
A Recipient is a Consumer or an owner of a Node or of a Branch.
A Consumer is an electricity user. This may also be a pump or reversible aggregate in load mode and every generator whose output is less then its auxiliary needs (for every Single Price Period during which power flows in the direction of a Unit it becomes a Consumer).
A Producer or a GenCo is the owner or operator of a Unit.
A Supplier is a GenCo or a TransCo or a DisCo.
A TransCo is the owner or operator of a part of a transmission network or of an entire transmission network.
A DisCo is the owner or operator of a part of a transmission network or of an entire transmission network.
A Bidder is a device installed at the control board of a Unit, which makes the Unit's market behavior automatic. It is programmed so as to offer bids of prices and power amounts in accordance with the Producers market strategy for every hour of a floating period of 24 hours ahead.
A Scheduler is a device installed at the control board of the system operator and programmed to reconcile the preliminary hourly bids for prices and power amounts, on the basis of which it commits the Units in accordance with expected system conditions.
A Price Designator is an additional multifunctional device installed at the System Operator control centre along with conventional systems for control and data acquisition and energy management. It is programmed to fulfil the following tasks: (i) to receive bids for the actual hour that have been committed according to the procedure for preliminary adjustment and to issue notices for price and required power output or required Ancillary Services to respective Units. (These notices are issued on the basis of the set of preliminary adjusted bids and on the nearest forecast for coming Single Price Periods); (ii) to receive actual power or Ancillary Service output levels and respective prices; (iii) to calculate the total system-wide costs (for Ancillary Services, for System Services, for liquidated damages and for allowances, if any); (iv) to calculate presumptive prices for system-wide expenses and to send the results to every Transmuter, and (v) to monitor the nodal prices and the actual Unit outputs and network conditions.
An Announcer is an additional programmable devise installed at the control board of a Unit along with the conventional management, bidding and control systems. It is programmed to fulfil the following functions: (i) to record the bids accepted by the System Operator at the preliminary dispatch stage, (ii) to receive the price of required power output or of Ancillary Services designated by System Operator for every subsequent price period, (iii) to verify that the price and product thus demanded fit within the previously contracted constraints and, if the verification succeeds, to send a confirmation back to the System Operator. If the verification fails, the Announcer substitutes the nearest acceptable value and sends it to the System Operator with an error notification. At the same time, the Announcer calculates the costs of involuntary deviations and sends the actual price and costs to the nodal Transmuter at the Node to which the Unit is connected.

The Bidder and the Scheduler are devices similar to existing ones and their detailed description here would unnecessarily complicate the presentation. The Designator and the Announcer, on the other hand, are novelties, therefore we describe their functions in detail in the present invention.
A Transmuter is an additional device installed at every Node along with conventional nodal equipment. It is programmed to fulfil the following functions at every Single Price Period: (i) to receive the amounts of power that Inlets bring to the Node and their prices, the costs for ancillary and System Services and the Node owner costs, (ii) to recalculate the prices for both ends of each Branch according to formulae (4), (5), (6), (7), (8), (11a), (16), (17), (18), (19), (21), (23), and (25) for the Single Price Period, and (iii) to send the results to neighbouring connected Nodes.
The Dynamic Advanced Prices (DAP) incorporate the main components of Advanced Nodal Prices [5] in such a way that payment for electricity becomes a function of a single parameter, namely, active power. These Dynamic Advanced Prices are based on the momentary balancing of costs and of recipient liabilities at every point of the network, where fairly allocated of system-wide costs also enter the balance. The price model takes into account the costs for power production, transmission, distribution and supply, for Ancillary and System Services, for security (liquidated damages and congestion fees), for transmission and distribution power losses and related allowances for Consumers who reduce network losses or congestion expenses, as well as for all other indispensable network expenses. These prices are calculated and transmuted according to the Nodal Equation and the Branch Equation for prices and charges (equations (1) and (5)) and the respective formulae derived from these equations.

Equations and Formulae Defining the Dynamic Advanced Prices

The proposed MPM price model takes into account the costs for power production, transmission, distribution and supply, for Ancillary and System Services, for security (liquidated damages and congestion fees), for transmission and distribution power losses and related allowances (for Consumers who reduce network losses or congestion expenses) and for all other indispensable network expenses. The costs for power production or liquidated damages, as well the costs for nodal services, emerge at the Node to which the corresponding Unit is connected and are propagated from there. The costs for power transmission or distribution and supply, as well as the related expenses for losses and congestion fees, emerge at the corresponding Branch through which power is transferred. In order to achieve a fair allocation of Ancillary and System service costs, we treat them according to the principle mentioned above and formally defined by the formulae below. The end Consumers are ultimately charged for all costs accumulated at the Node where the Consumer's Outlet is connected.

The Dynamic Advanced Prices incorporate the mentioned costs in such a way that the amounts charged for electricity become a function of a single parameter, namely, active power. The use of such prices is technically feasible at reasonable costs.

The invention as a whole and the Dynamic Advanced Prices in particular are based on the momentary balancing of power costs and charges for such costs at every single network point. We next describe this in greater detail.

Current flowing from the Units trough network elements towards the Consumers ideally carries not only power but also the cost for its production. If we imagine power as a transportable commodity passing to the next network point only if somebody buys it into his possession and then move it, we arrive at the idea of a system of charging under which at every subsequent network point costs incurred up to this point are offset by charges down the route of power flow. Thus we conceive an abstract flow of monetary amounts charged, which travels in the direction contrary to that of the power flow, thus from Consumers through network elements towards Producers, so as to offset the related costs. This concept illustrates the principle for balancing costs with amounts charged at every network point. Applying this principle to every Node and to both ends of every Branch, we define two equations for costs and prices—a Nodal Equation and a Branch Equation.

Theoretically, the case exists when the bilaterally contracted price at the Supplier's (Producer's) Node is higher than the actual price at the Consumer's Node. In such a case, the System Operator should have to pay a kind of an Allowance to the Consumer for his reducing the costs for transmission losses by more than the sum of network and congestion charges. For the sake of clarity, this theoretical case is not indicated in the formulae below, but its inclusion is straightforward.

Notation

The following notation is used:

C_{g} C_{Zin}, C_{nod}, C_{AS}, C_{SS} are the costs correspondently for generation g, for supplied flow Zᵢₙ, for owner of the Node, for Ancillary and for System Services;
C_{Li}, C_{iC&O}, C_{sec} are the correspondent costs for active power losses Li at Branch i caused by power flow Zᵢₙ, for capital and operational costs of the owner of the Branch i, for security (congestion avoidance);
j—a Unit index;
J—the set of all connected and power generating Units j, ∀jεJ;
Jₙ—the set of all connected to Node n and power generating Units j, Jₙ⊂J;
J^{α}—the set of all Units providing ancillary serves α, J^{α}⊂J;
n,m,κ—Nodes indexes:
k—a index of Node k from which power is drawn out according to bilateral Agreement, ∀kεNₖ, Nₖ⊂N;

### N—the set of Nodes n, m, κ, ∀n, m, κεN;

gⱼₙ—the recorded total power output in MW sold by Unit j to Node n for both bilaterally and public agreements during the corresponding Single Price Period (gⱼₙ=g^{δk}ⱼₙ+gⱼₙ^{p});
g^{δk}jn—the recorded power in MW sold by Unit j to Node n for bilateral Agreement with Consumer δ connected to Node κ during the corresponding Single Price Period;
gⱼₙ^{p}—the recorded power in MW sold by Unit j to Node n for public Agreement during the corresponding Single Price Period;
γⱼₙ^{g}—the sell price in $/MW or £/MW or [symbol] /MW etc. announced by Unit's j Announcer for generation output g to Node n for the corresponding Single Price Period;
γ̅jn^{g}—the cap for sell price in $/MW or £/MW or [symbol] /MW etc. for floating day ahead at which Unit j is committed for its operating range;
γjn^{δκ}—the sell price in $/MW or £/MW or [symbol] /MW etc. announced by Unit j Announcer for generation output d^{δk}ⱼₙ=g^{δk}ⱼₙ to Node k for bilateral Agreement with Consumer δ for the corresponding Single Price Period;
γⱼₙ^{p}—the sell price in S/MW or £/MW or [symbol] /MW etc. announced by Unit j Announcer for generation output g^{p} to Node n for TransCo/DisCo according public Agreement for the corresponding Single Price Period;
α—an index for an ancillary in a volume criterion A;
γj^{α}—the sell price in $/A or £/A or [symbol] /A etc. announced by Unit j Announcer for commitment of an ancillary A for the corresponding Single Price Period;
γ̅ⱼ^{α}—the cap for sell price in $/A or £/A or [symbol] /A etc. at which Unit j is committed for floating day ahead for ancillary A;
j—a Branch index;
Iₙ—the set of all conjoined Branches i in Node n, Iₙ⊂I, ∀iεI;
Iᵢₙ—the set of all Inlets supplying power Zᵢₙ from Branches i to Node n during the corresponding Single Price Period, Iᵢₙ⊂Iₙ;
Iₙᵢ—the set of all Outlets carrying out power Zₙᵢ from Node n trough Branch i to Node m or Consumer δ during the corresponding Single Price Period, Iₙᵢ⊂Iₙ;
Zᵢₙ—the recorded power in MW sold by Inlet i to Node n during the corresponding Single Price Period;
Z̅ᵢₙ—the congestion limit in MW (maximum capacity allowed to be transferred trough Inlet i to Node n);
Zₙᵢ—the recorded power in MW sold from Node n to Outlet i during the corresponding Single Price Period;
γᵢₙ—the sell price in $/MW or £/MW or [symbol] /MW etc. for the power Zᵢₙ sold trough Branch i to his end Node n started from the Transmuter at the start Node m and received in the Transmuter at the end Node n;
γₙᵢ—the sell price in $/MW or £/MW or [symbol] /MW etc. for the power Zₙᵢ sold from start Node n to Branch i;
γ_{gAS}—the assumptive nodal Unit power price in $/MW or £/MW or [symbol] /MW etc. for total Ancillary Services costs remuneration, calculated by SO's Designator and received in every Transmuter to the Node of which at least a Unit is conjoint;
γ_{gSS}—the assumptive nodal Unit power price in $/MW or £/MW or [symbol] /MW etc. for total System Services costs remuneration, calculated by SO's Designator and received in every Transmuter to the Node of which at least a Unit is conjoint;
γ_{nodn}—the sell price in $/MW or £/MW or [symbol] /MW etc. for capital and operating nodal costs remuneration declared by the Node owner to the Node Transmuter, recalculated to outgoing from Node power;
δ—a Consumer index;
d^{δk}—the total recorded power in MW sold to Consumer δ Outlet conjoint to Node k which is supplied simultaneously according bilateral Agreement (Unit j conjoint to Node n) and public Agreement (TransCo or DisCo) during the corresponding Single Price Period;
d^{δk}ⱼₙ=g^{δk}ⱼₙ—the bilaterally contracted power in MW sold to Consumer δ Outlet conjoint to Node k supplied from Unit j conjoint to Node n during the corresponding Single Price Period;
d^{δk}ₚ—the power in MW sold to Consumer δ Outlet conjoint to Node k supplied from public Agreement Supplier (TransCo or DisCo) during the corresponding Single Price Period, d^{δk}ₚ=d^{δk}−d^{δk}ⱼₙ;
Bⱼ^{δ}—the Consumer δ charge in $ or £ or [symbol] etc. according bilateral Agreement to Producer Unit j for corresponding Single Price Period;
B^{p}—the Consumer charge in $ or £ or [symbol] etc. according public Agreement to TransCo/DisCo/PoolCo for corresponding Single Price Period;
Co′—is a compensation in $ or £ or [symbol] etc. for involuntary difference between bilaterally contracted and actual power consumed for corresponding Single Price Period;
Co″—is a compensation in $ or £ or [symbol] etc. for involuntary difference between dispatched and actual Unit power output for corresponding Single Price Period;
LD—is a sum in $ or £ or [symbol] etc. for liquidated damages in case of SO order for a Unit output decrease for security reasons.
spp—Single Price Period.

The Nodal Equation for Balancing Costs with Amounts Charged

The Nodal equation for prices defines relations between prices for power and services entering into a Node and prices for power outgoing from the same Node. This equation is based on the balance between costs and amounts charged at the Node and also on the principle that charges at the outgoing charging points have to remunerate all costs collected or incurred at the Node.

At Node n, every Single Price Period has an associated sum of costs. The first term in this sum represents the costs for power supplied by Units; it includes the compensation for any previous involuntary deviations and liquidated damages (if any output decrease is ordered by the SO.) The second term represents the costs for incoming power from Inlets. The third represents the Node owner's costs incl. nodal services cost. The fourth represents the System Operator's costs for Ancillary Services provided by Units. The fifth one represents the System Operator's costs for System Services. These total costs are balanced by charges for all Outlet power flows.

Hence the Nodal Equation that expresses the balance of costs with charges is as follow:

$${C}_{g} + {C}_{Zin} + {C}_{nod} + {C}_{AS} + {C}_{SS} = {γ}_{ni} {\sum }_{i ∈ lni} {Z}_{ni} = ( {γ}_{gni} + {γ}_{Zni} + {γ}_{nodni} + {γ}_{ASni} + {γ}_{SSni} ) {\sum }_{i ∈ lni} {Z}_{ni} . \qquad ( 1 )$$

Detailed Costs Consideration:
The costs C_{g} for a power g supplied by conjoint Units

A few Units j and Consumers δ can be conjoint to the Node n in a common case. A Consumers demand can be supplied by a Producer based on a bilateral agreement (d^{δk}ⱼₙ=g^{δk}ⱼₙ) or by the public Supplier (d^{δk}ₚ) or simultaneously d^{δk}=d^{δk}ₚ+d^{δk}ⱼₙ.

A Unit j can supply power for a few Consumers by bilateral agreements (g^{δk}ⱼₙ) or for the Pool/TransCo/DisCo/RTO (gⱼₙ^{p}) i.e.

$${g}_{jn} = {\sum }_{δ} {g}_{jn}^{δ k} + {g}_{jn}^{p} . \qquad ( 2 )$$

The costs that a Units jεJₙ have to charge for these power supplied to Node n is:

$${C}_{jn} = {γ}_{jn}^{g} {g}_{jn} = {\sum }_{δ} {g}_{jn}^{δ k} {γ}_{jn}^{δ k} + {g}_{jn}^{p} {γ}_{jn}^{p} + {Co}^{′} + {Co}^{″} + LD . \qquad ( 3 )$$

The costs that all Units jεJₙ conjoint to a Node n have to charge for the power supplied to the Node n is:

$${C}_{Jn} = {\sum }_{j ∈ {J}_{n}} {γ}_{jn}^{g} {g}_{jn} = {\sum }_{j ∈ {J}_{n}} ( {\sum }_{δ} {g}_{jn}^{δ k} {γ}_{jn}^{δ k} + {g}_{jn}^{p} {γ}_{jn}^{p} + {Co}^{′} + {Co}^{″} + LD ) . \qquad ( 4 )$$

These costs, as well the costs for Inlet's power, the owner' costs, and the System Operator' costs for Ancillary and System Services, have to be remunerateed by the cost of the total power outgoing from the Node n. Hence the Units' part price for charging outgoing from a Node n power is defined as:

$${γ}_{gni} = \frac{{C}_{Jn}}{{\sum }_{i ∈ lni} {Z}_{ni}} = \frac{{\sum }_{j ∈ {J}_{n}} {γ}_{jn}^{g} {g}_{i n}}{{\sum }_{i ∈ lni} {Z}_{ni}} . \qquad ( 5 )$$

The costs C_{Zin} for power Zᵢₙ supplied by Inlets

By analogy with a Unit j the Inlet i supply to a Node n power Zᵢₙ on price γᵢₙ

The costs that all Inlets iεIᵢₙ conjoint to Node n have to charge to Node n for the power Zᵢₙ supplied is:

$${C}_{Zin} = {\sum }_{i ∈ lin} {γ}_{i n} {Z}_{i n} . \qquad ( 6 )$$

These costs, as well the costs for Unit's power, the owner' costs, and the System Operator' costs for Ancillary and System Services, have to be remunerate by the cost of the total power outgoing from Node n. Hence the Inlet's part price for charging outgoing from a Node n power is defined as:

$${γ}_{zni} = \frac{{C}_{Zin}}{{\sum }_{i ∈ lni} {Z}_{ni}} = \frac{{\sum }_{i ∈ lin} {γ}_{i n} {Z}_{i n}}{{\sum }_{i ∈ lni} {Z}_{ni}} . \qquad ( 7 )$$

The costs C_{nod} for the Node n owner:

The costs for the Node n owner for a single price interval (price of the services provided by the owner of the Node) include operational and capital costs and profit recalculated for a Single Price Period. These costs, as well the costs for Unit's power, the costs for Inlet's power, and the System Operator' costs for Ancillary and System Services, have to be remunerate by the cost of the total power outgoing from Node n. Hence the Node owner' part price for charging outgoing from a Node n power is defined as:

$${γ}_{nni} = \frac{{C}_{nod}}{{\sum }_{i ∈ lni} {Z}_{ni}} . \qquad ( 8 )$$

The costs C_{AS} for Ancillary Services

In addition to the power a Unit j can provide to a Node n also an Ancillary Service a measured by criterion A on price γ_{jα} in $/A or £/A or [symbol] /A etc. That is the price for availability of the service.

The costs a Unit j conjoint to a Node n has to charge to the System Operator for Ancillary service α are:

$${C}_{j α n} = {\sum }_{α} {γ}_{j α n} A . \qquad ( 9 )$$

The total costs that all Units jεJ^{α}⊂J have to charge to the System operator for provided Ancillary Services to the whole EPS are:

$${C}_{AS} = {\sum }_{n ∈ N} {\sum }_{j ∈ J} {C}_{j α n} = {\sum }_{n ∈ N} {\sum }_{j ∈ J} {\sum }_{α} {γ}_{j α n} A . \qquad ( 10 )$$

This sum of the actual Ancillary Services costs (10) is defined by the System Operator's Designator for every Single Price Period. The costs incur at the Node to which the providers of specific Ancillary Services are conjoint but are paid finally by all users of the services i.e. all final Consumers. All final Consumers have to pay equally allocated charges for Ancillary Services and for the rest of the system-wide costs (System Services and network security support includes liquidated damages, allowances and congestion fees).

The equal allocation is provided by the System Operator's Designator in combination with Nodal Transmuters. The Designator converts the actual sum of charges into assumptive nodal Unit power price (generation price parts, allocated to every Node to which at least a Unit is conjoint). The assumptive price is proportional to the partition between total AS costs and the total power output of the all Units. We assume this price is an added part to the Unit production price that starts at every Unit (not only at AS providers). That is why the assumptive price has to be transmitted to every Transmuter to which Node at least a Unit is conjoint. There this price adds to individual Unit price and the other nodal price parts. The result is converted into price for outgoing power and is transmitted again according the price way (opposite to power flows). Similar Principle is suggested for the System Services, provided directly from the System operator to all Producers and Consumers. Based on the mentioned assumption and explanations, this added price part, by which the Ancillary costs start at each Unit charging point, is equal for all Units and is defined as:

$${γ}_{g AS} = \frac{{C}_{AS}}{{\sum }_{n ∈ N} {\sum }_{j ∈ J} {g}_{jn}} = ( {\sum }_{n ∈ N} {\sum }_{j ∈ J} {\sum }_{α} {γ}_{j α n} A ) / {\sum }_{n ∈ N} {\sum }_{j ∈ J} {g}_{jn} . \qquad ( 11 )$$

Hence the Ancillary Services price, recalculated to outgoing from Node n power Zₙᵢ (by which the Ancillary costs start at Outlets charging point level) is equal for all Outlets at Node n and is define as:

$${γ}_{ASni} = \frac{{\sum }_{j ∈ J} {γ}_{gAS} {g}_{i n}}{{\sum }_{i ∈ lni} {Z}_{ni}} . \qquad ( 11 a )$$

The costs C_{SS} for System Services

By analogy to the Ancillary Services we define the assumptive nodal Unit power price (added Unit power price part for the System Services γ_{gSS}, recalculated to Units generation gⱼₙ). This assumptive price is equal for all the Units in all the Nodes at which System Services costs start (Unit charging point level) and is:

$${γ}_{gSS} = \frac{{C}_{ss}}{{\sum }_{n ∈ N} {\sum }_{j ∈ J} {g}_{jn}} . \qquad ( 12 )$$

Hence the System Services price, recalculated to outgoing from Node n power Zₙᵢ (by which System Services costs start at Outlets charging point level) is equal for all Outlets at Node n and is define as:

$${γ}_{SSni} = \frac{{\sum }_{j ∈ J} {γ}_{gSS} {g}_{jn }}{{\sum }_{i ∈ lni} {Z}_{ni}} . \qquad ( 12 a )$$

The price for power outgoing from Node n to Branch i

Based on the formulae composed so far we can define the price for power outgoing from Node n to Branch i as a sum of all price parts in (5), (7), (8), (11a), (12a):

$${γ}_{ni } = {γ}_{gni} + {γ}_{Zni} + {γ}_{nodni} + {γ}_{ASni} + {γ}_{SSni} == \frac{{\sum }_{j ∈ J} ( {γ}_{jn} + {γ}_{gAS} + {γ}_{gSS} ) {g}_{jn} + {\sum }_{i ∈ lin} {γ}_{i n} {Z}_{i n} {C}_{nod}}{{\sum }_{i ∈ lni} {Z}_{ni}} . \qquad ( 13 )$$

For Nodes with no conjoint Unit equation (13) reduces to:

γₙᵢ=γ_{Zni}+γ_{nodni} (14).

The costs equation (3) is programmed on the Announcer of every Unit.

The costs/prices equations (10), (11) and (12) are programmed on the Price Desgnator.

The price equation (13) or respectively (14), as well their terms (4), (5), (6), (7), (8), (11a) and (12a) are programmed on the Transmuter of every Node. Based on these the data recorded on meters or received from the Announcers and from the Price Designator are converted into price for power outgoing from Node n (periodically at each Single Price Period or upon certain changes of data). Then the converted prices are transmitted to next connected Node m.

The Branch Equation for Balancing Costs with Amounts Charged

The Branch equation for balancing costs with charges defines relations between price γₙᵢ for power Zₙᵢ at the beginning/starting charging point of the Branch i, connecting Node n with Node m, and the price γᵢₘ of power Zᵢₘ at the end point of the same Branch. This equation is based on the balance between costs and charges along the Branch i.e. on the principle that charges at the end charging point have to remunerate all costs incurred along the Branch.

A sum of costs imports or incurs every Single Price Period along the Branch. The first term of the sum represents the costs for transferred/distributed power at the beginning/starting point of the Branch. The second term of the sum represents the costs of losses trough the Branch. The third one represents Branch owner' costs. The forth one represents the costs for congestion avoidance in case if actual transferred capacity is biggest then maximum allowed transferred capacity (both by thermal or by stability constraints). The total costs have to be remunerated by the charges/receipts for the power flow at the end of the same Branch.

The Node n is the beginning point of Branch i if power is directed from Node n to Branch i correspondently Node m. The beginning point moves to Node m if power changes its direction and Node n becomes end point. Theoretically both Nodes n and m can be beginning points at one and the same Single Price Period. It happens when both nods supply Branch losses only. It is impossible to remunerate the Branch owner' costs in this case. Such periods have to be considered when the Branch owners calculate their Single Price Period costs.

Hence the Branch equation that expresses costs with charges balance is as follow:

γₙᵢZₙᵢ+C_{Li}+C_{iC&O}+C_{sec}=(γₙᵢ+γ′_{iL}+γ′_{iC&O}+γ′_{isec}) Zₙᵢ=γᵢₘZᵢₘ (15).

The costs C_{Li} include costs for real power losses Li caused by transmitted/distributed power Zₙᵢ trough Branch i . The Corona losses do not depend on a power flow Zₙᵢ and it is more easy and correct to be including in operational expenses of the Branch.

The price for losses γ′_{iL}, by which the costs C_{Li} have to be remunerated, is determined at the beginning of the Branch i (noted ′) as follow:

$${γ}_{iL}^{′} = \frac{{γ}_{ni} ( {Z}_{ni} - {Z}_{im } )}{{Z}_{ni}} . \qquad ( 16 )$$

The costs C_{iC&O} include capital and operational costs and the profit for the owner of the Branch i or in another words total cost of transmission/distribution services of this Branch for a Single Price Period.

The price for capital and operational costs γ′_{iC&O}, by which the costs C_{iC&O} have to be remunerated, is determined at the beginning of the Branch i (noted ′) as follow:

$${γ}_{i C \& O}^{′} = \frac{{C}_{iC \& O}}{{Z}_{ni}} . \qquad ( 17 )$$

The costs C_{sec} include costs for security (congestion avoidance). Here is proposed an example based on a quadratic penalty function for congestion fee P calculation.

P=(s Z̅ᵢₘ−Zᵢₘ)² if (s Z̅ᵢₘ−Zᵢₘ)>0 and

P=0 if (s Z̅ᵢₘ−Zᵢₘ)≦0,

where s is a security marginal factor, for example s=0.9.

The price γ′_{isec} for these costs is determined to the beginning point of Branch i (noted ′) as follow:

$${γ}_{isec}^{′} = \frac{{γ}_{ni} P}{{Z}_{ni}} . \qquad ( 18 )$$

Upon rewriting Branch price equation (15) for the price γᵢₘ, of the power Zᵢₘ at the end Branch charging point became:

γᵢₘ=γₙᵢ+γ′_{iL}+γ′_{iC&O}+γ′_{isec} (19).

The Branch price equation (19) and its terms (16), (17) and (18) are programmed on the Transmuter of each Node. Based on this the beginning charging point price γₙᵢ which comes from Node n (connected to Node m by Branch i) is increase with the price for losses γ′_{iL} (caused by recorded on meters power flow Zₙᵢ and Zᵢₘ) and with the price γ′_{iC&O} for received from Branch owner costs and finally with the price for congestion fee γ′_{isec}. Thus the beginning charging point price γₙᵢ is converted to the price γᵢₘ for outgoing from the Branch i power, which at the same time is an Inlet i price for the Node m. The latter is used as an input data for the Transmuter at Node m according equation (13) or (14).

Prices Rout

Presumably the power sell prices γ^{δk}ⱼₙ according bilateral agreements are long term prices. Similar is the case for the Ancillary Services prices γ_{jαn}.

The Unit's power sell prices γⱼₙ^{p} according Public agreement can be based equal on expenses/costs Principle or on Producer's strategy and tactics for market interest [11], [14], [15]-[17], [23], [28]. It is our believe that the market participation theory will bear further development after this invention became published.

We presume an almost automated procedure for price preparation, formation and propagation. It envisages two stages: preliminary adjustment of the hourly bids and a constant repetition of price formation and propagation for every Single Price Period (see FIG. 2). A constantly updated data set is used for both stages, based on ramp rating characteristics and the nearest forecast for the demand and the network conditions. The main data flows could be seen on FIG. 4.

At the preliminary scheduling & dispatching phase the Units bid their bids time and again not for every Single Price Period but hour by hour for a floating day ahead. This is a process for adjusting the bids with coming actual conditions. The aim of this phase is to clear hourly bids and to commit the Units for a floating day ahead according their bid price (price quota curve). The preliminary adjustment, scheduling and dispatching phase is very similar to the known practices in day and hour ahead markets. The main difference is that these markets are merged and the closing time is shifted every hour. It closes for example one hour before the actual hour starts.

The second phase consist of a constant repetition of price formation and propagation for every Single Price Period inside the actual going hour. At the moment ‘t-spp’ (let say a minute before the actual Single Price Period starting in the moment t) the System Operator designates the output level (operation point) and the respective price inner to the operational rang and price curve (adjusted bid). In case of shut down or starting up for coming actual single period(s) the System operator designates the new Unit status and notices Unit operators for this. The Announcer of Units verify that these price and product demanded fit within the previously contracted constraints and in case it is so to send the confirmation back to the System Operator and to set out the governor according system operator's notice. If the verification fails the Announcer substitutes the likely acceptable value and sends it to the System Operator with an error notification. In addition to this Unit Announcer set out compensation costs for two types of deviations: (i) between bilaterally contracted and actual consumption according equation (26), (ii) between dispatched and actual Unit power output for every Single Price Period according equation (27). If the Announcer receives from the Designator a non-zero value for liquidated damages it adds this value to the correspondent costs.

At the moment t the Announcer sends the actual costs (Cⱼₙ) of its output to the nodal Transmuter at the Node to which the Unit is connected, calculated according equation (3). The Announcer sends also the actual Ancillary Services costs of the Unit j (C_{jαn}) to the System Operator's or Distribution Operator's Price Designator, calculated according equation (9). Price Designator receives also the actual Unit output (gⱼₙ) from the Transmuters and calculates the price parts for Ancillary γ_{gAs} and for System γ_{gSS} services by formula (11) and (12) and sends them to every Transmuter at the Node to which at least one generation Inlet is actual.

At the moment t+spp (end of actual Single Price Period) the Transmuter in the Node n reads recorded power flows on every Inlet Zᵢₙ, prices for this powers γ_{Zin} and nodal owner costs C_{nod}. Transmuter calculates price γ_{Zni} for outgoing flows Zₙᵢ by formula (13) or (14) for all Outlets (including Consumer's one) from Node n, iεIₙ.

If we neglect time for nodal Transmuter calculations we can assume that at the same moment t+spp prices γ_{Zni} and power Zₙᵢ are transmitted via Inlet i to the Node m (end charging point for Branch i connecting n with m). In few milliseconds Transmuter in Node m receives prices γ_{Zni}. The power flow Zᵢₘ, costs C_{iC&O} and security fee (if any) are already recorded on the Transmuter at Node m. This Transmuter adds price components γ′_{iL}, γ′_{iC&O}, and γ′_{isec} to the price γ_{Zni} according formula (16), (17), (18) and (19). The resulted price γ_{Zim} is considered as an Inlet price to the Node m. Then the Transmuter recalculates the prices for Outlets from Node m in analogy of explanation for Node n above.

In this sequence, following flow direction on all Branches, the initiated prices are recalculated and converted and in few seconds this iteration and circulating process reach congruence. In a regulated technology cycle of not more than few seconds every final Consumer could receive in his intelligent meter the official price for public power supply γₖᵢ for the actual Single Price Period already passed.

The process for price formation and propagation explained briefly above is perpetually repeated for every Single Price Period (spp).

Main Features of Charging, Settlement and Payment

The every intelligent meter receives the price for every Single Price Period and measures the electrical energy transferred or used over that period. It than calculates the average power between two price changes and stores both the power and the price for the single period. Then the meter calculates the hourly, daily, weekly or monthly bill. These data can be stored for archive and for forecast purposes. They are available for both the Supplier and the Recipient. Thus every market participant is informed about actual or historical price or power or bill. Every one of them controls the value he is interested in: the power or the energy supplied, or transferred, or distributed, or consumed and of course the costs or the charges or the liabilities. Client is not any more forced to wait for some body to read meters then to make billing and settlement for him. By simple procedures Consumers can check their bills and can arrange automated payments. The simplicity and the other advantages are obvious.

In case of mixed power supply simultaneously from specified Producer (Unit j) and from public Supplier there is a necessity for some more explanations. There are three cases subject to difference between actual consumed/recorded power d^{δk} and bilateral contracted one d^{δk}ⱼₙ.

At the first case the actual consumed/recorded power d^{δk} and the bilaterally contracted one d^{δk}ⱼₙ are equal (the difference is in a contracted tolerance margin). The Consumer is charged for this supplied power g^{δk}ⱼₙ=d^{δk}ⱼₙ by Unit's costs

Bⱼ^{δ}=γ^{δk}ⱼₙg^{δk}ⱼₙ=γ^{δk}ⱼₙd^{δ}ⱼₙ (20)

based on the contracted price γ^{δk}ⱼₙ. The Consumer also has to pay to TransCo/DisCo for transmission/distribution power d^{δk}ⱼₙ a service fee based on the difference between public price at the Node n (where Unit j is conjoint) and the public price at Node k amounted to

B^{p}=d^{δk}ⱼₙ(γ_{Zki}−γ_{jZni}) (21).

At the second case the actual consumed/recorded power d^{δk} is bigger than the bilaterally contracted one d^{δk}ⱼₙ=g^{δk}ⱼₙ. The Consumer is charged by the Producer (Unit) for the supplied power g^{δk}ⱼₙ based on the contracted price γ^{δk}ⱼₙ by a bill

Bⱼ^{δ}=γ^{δk}ⱼₙg^{δk}ⱼₙ=γ^{δk}ⱼₙd^{δk}ⱼₙ (22),

and by TransCo/DisCo for a service payment based on the difference between the public price at Node n (where Unit j is conjoint) and the public price at Node k a bill B^{p′} according equation (21).

In addition to this the Consumer has to pay to the public TransCo/DisCo the excess consumed power d^{δk}−g^{δk}ⱼₙ on the TransCo/DisCo price γ_{Zki} at the Node k a bill amounted to

B^{p″}=γ_{Zki}(d^{δk}−g^{δk}ⱼₙ) (23).

At the third case the actual consumed/recorded power d^{δk} is less than the bilaterally contracted one d^{δk}ⱼₙ. The Consumer has to pay for the supplied power g^{δk} to Producer (Unit) based on contacted conditions (usually a payment on contracted price γ^{δk}ⱼₙ plus a liquidated damages) a bill

Bⱼ^{δ}=γ^{δk}ⱼₙd^{δk}+contracted penalty (24).

The Consumer has to pay to the public TransCo/DisCo a service payment based on the difference between the public price in Node n (where Unit j is conjoint) and the public price in Node k that is similar to this of equation (21) and amounts to

B^{p}=d^{δk}(γ_{Zki}−γ_{jZni}) (25).

In addition to said above the Producer (Unit) has to pay to or is being paid from the owner of the Node n (to which Unit j is conjoint) as a primary compensation for involuntary delivery of difference g^{δk}ⱼₙ−d^{δk} to/from TransCo/DisCo. This delivery difference is charged based on the price difference between initiated bilateral and public price i.e.

Co′=(g^{δk}ⱼₙ−d^{δk})(γ^{δk}ⱼₙ−γⱼₙ^{p}) (26).

By the Announcer at Unit j this compensation is added/subtracted to/from costs/incomes of Unit j in formulae (3) and is compensated for the second to the last Single Price Period.

In the case a Unit output gⱼₙ is less or bigger than tolerance margin of the dispatched value gⱼₙ^{d} a second compensation for involuntary delivery of difference gⱼₙ−gⱼₙ^{d} to/from TransCo/DisCo is calculated based on public nodal price i.e.

Co″=(gⱼₙ−gⱼₙ^{d})γⱼₙ^{p} (27).

By the Announcer at Unit j this second compensation is added/subtracted to/from costs/incomes of Unit j in formulae (3) and is compensated for the second to the last Single Price Period.

In the case when System Operator is charged by a non-zero liquidated damages the value of this damages LD also has to be added to the incomes of a Unit j according to the formulae (3).

MPM Advantages

At the end of technical essence of the invention described above we present briefly some of the advantages of our approach in comparison with the existing market models:
Up to now, different bodies using different procedures determined the price of supply and demand. Just the market administrator usually knows bids from various Units. Every market participant knows the closing price but no one knows the prices of the competitors. The end Consumer's prices do not reflect wholesale prices changeability. Our method proposes that every committed Producer declares/announces openly his price and this price be transmitted through the network in order to incorporates the price of transmission, distribution etc. into the final price. Thus, the energy could reach the end user labelled with a current market price. The Consumers could react immediately to the price variations;
Up to now, the network was viewed as one distinct whole, which was owned as a Unit by one owner. There was no mechanism that could transmit the individual costs of different HV Lines, transformers and other network elements to the end users price. This hindered the recovery of expenses put into those and acted as a hindrance to private capital. Under our proposal, a mechanism that takes those into account has been devised. Each element in the network carries its price towards the end user and can be reimburse separately. This creates economic conditions that stimulate competitive private and public investors both for the production and for the network;
The need to have four physical markets complemented each other in time: week-ahead, day-ahead, hour-ahead and real-time (balancing) markets is eliminated and is replaced by free market participants behavior and by two-phases automated procedure.
The need for creating the most complex market—the market for balance energy—is eliminated;
The need to have a specific trade environment (a power exchange, market administrator and intermediaries) is eliminated, and the whole process of supply and demand as we know it is changed;
The need for coming up with all kinds of rates and tariffs is eliminated (and thus the problems originating from those are resolved);
Billing and settlement are both drastically changed;
There is a legal and economic equality among all kinds of users—small-scale or large-scale, eligible or non-eligible, industrial or residential;
Congestion forecast and management are resolved solely according to market principles and the existing complex principles for allocation of market rights become unnecessary;
The so cold interface problems (regional prices, cross-border trade, transmission to distribution and vice versa exchanges etc.) are resolved by an exclusively market manner;

### BRIEF DESCRIPTION OF THE DRAWINGS

The invention will be better described with reference to the next drawings, in which:

FIG. 1 is an illustration of a unifying of the Markets for physical bilateral and public electricity sells with the Market for Services (especially security) based on a equitable allocation of the system-wide expenses and power purchase on the price labelled for the last minute according to the Momentary Power Market proposed in this invention.

FIG. 2 is a table specification of the main Market participants activities in different time periods related to the Momentary Power Market according to this invention in addition to their inherent activities like production, transmission, distribution, A&SSs Providing, etc. or to Bilateral and Financial markets activities;

FIG. 3 is an illustration of the disposition of the devices proposed by the invention on a single line diagram of a part of an Electric Power System and a Distribution Network. Standard symbols have been used for conventional network elements: a sinusoid inside a circle for Unit, a number inside a circle for Node, a continuous thick line for the power transmission and distribution Branches or Unit's Inlets or Consumer's Outlets. Dot-dash thin lines separate the distribution network and the rest part of the EPS. The devices proposed are illustrated as follow:

FIG. 4 is an illustration of the main data flows for price formation and propagation according to the main embodiment of the invention. The Unit bid has shown like price power curve. The formulae (numbers in brackets) are programmed on the Transmuters. The communication lines are illustrated by continuous thick line when they coincide with power network Branches. Otherwise they are double dot-dash thin lines;

FIG. 5 is an illustration of the main data flows for price formation and propagation according to the additional embodiment of the invention. The symbols are the same as in FIG. 4, but here are not Transmuters at the Nodes and the formulae (numbers in brackets) are programmed on the price Designator.

### BEST MODE FOR CARRYING OUT THE INVENTION

We present here a detailed account of the ways of carrying out the invention claimed. Nevertheless the explanation as well figures described above have been simplified to illustrate features that are relevant for a clear understanding of the present invention, while eliminating, for purposes of clarity, other components found in a typical Electricity Markets of contemporary EPSs. For example, bidding and clearing systems, specific operating system details, rules or facilities like communication carriers; SCADA/EMS or WAMS and other applications are not treated. Those of ordinary skill in the art will recognize that other elements are desirable or required in order for the Momentary Power Market suggested by the present invention to reach an operational state. However, because such elements are well known in the art, and because they do not contribute to a better understanding of the present invention, a discussion of such elements is not provided herein.

### The Main Embodiment

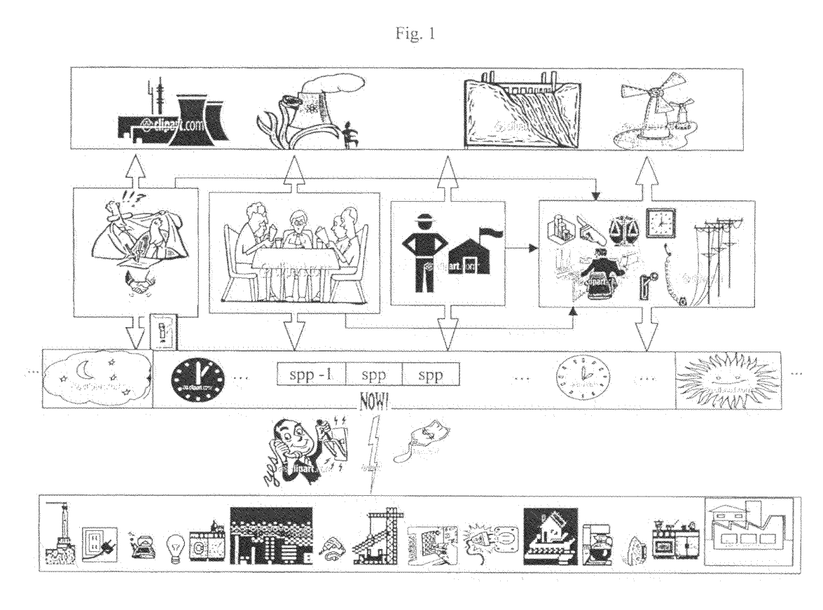

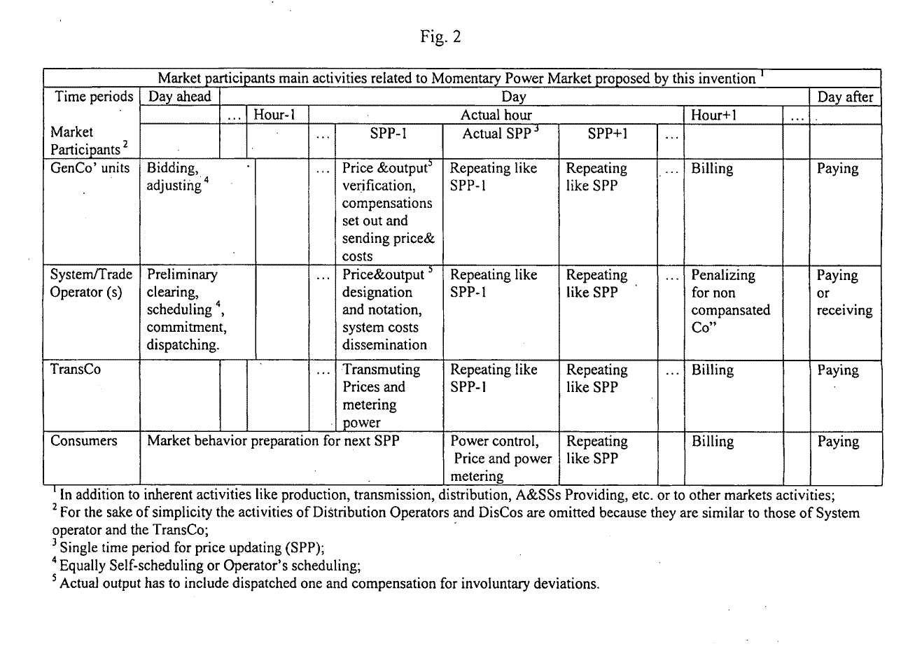

The main embodiment of the invention pertains to integration in infrastructure and functioning of Power Market and power systems. It envisages a single market, where adjustment and balancing are the result of three concurrent activities: the preliminary adaptation to expected real-time conditions, the fixing of the trading price for the current time (next Single Price Period), and the compensation of involuntary deviations that have occurred during preceding Single Price Period (see also market illustration on FIG. 1 and main market participants activities in FIG. 2).

### The Essence of the MPM Main Embodiment is:

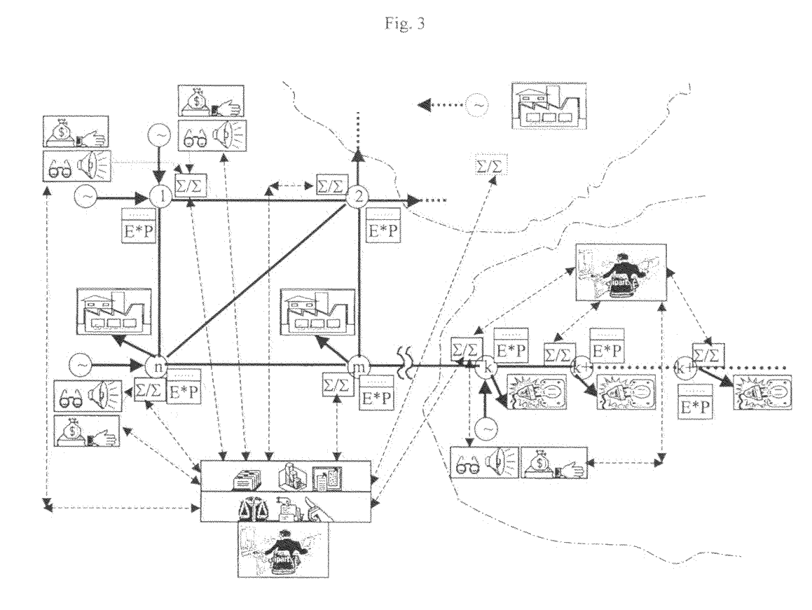

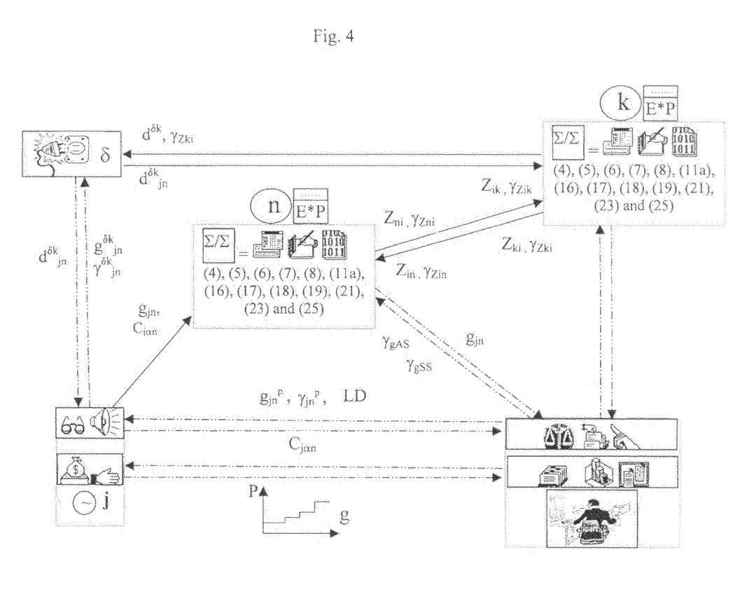

On the basis of every Producer's freely determined hourly bids for sale of electric power or Ancillary Services the System (Distribution) operator provides clearing, scheduling and commitment every hour for a floating day ahead. In the second automated procedure, which is applied at every Single Price Period, the system operator determines the price and the dispatched amount of power or Ancillary Services, within every Unit's working range, that are to be realized over the next Single Price Period, and notifies the Unit operator of every Unit. The Unit operator verifies that the goods demanded of him and their price are within the previously agreed range and, if so, sends a confirmation to the system operator and adjusts the Unit governor to the given settings. If the verification fails, the Unit operator adjusts the Unit to the nearest acceptable settings and notifies the system operator. At the same time, the Unit operator declares/announces the actual price and sends it, along with the values of the two kinds of involuntary deviations realized over the preceding period, to the Transmuter at the Node where the Unit is connected. Then these prices went trough a decentralized conversion and transmitting (jargonized here ‘transmution’) of the actual prices to every network Node including final Consumers by means/using power network as communication and model environment based on an improvement of existing data acquisition subsystem. In order to provide such functions a system of devises are proposed, named here Bidder, Scheduler, Price Designator, Price Announcer, Price Transmuter and Intelligent Electrometer (see FIG. 3 and FIG. 4).

The characteristics of the MPM main embodiment are as follow:
The Goods (Products) traded are:
Active power sold between market participants at its actual price of the moment;
Ancillary Services sold to the System Operator by Producers.

The power transmission or distribution via Nodes or Branches is a service but not good. The owners of network elements are obligated for provision of such service. They charge power Recipients for service costs. The charge results on the total expenses divided to the power transferred for a Single Price Period.
The Market participants could be:
Every Producers;
Every Consumers (even small residential ones);
The System Operator (whether an Independent or a Pool or an RTO or a TSO operator) in his capacity of an obligatory mediator;
All TransCos (RTOs) or owners of the entire transmission network or its parts in their capacity of obligatory mediators;
All DisCos (ESCos) or owners of the entire distribution network or its parts in their capacity of obligatory mediators;
All Distribution Operators in their capacity of obligatory mediators.
The Main types of Agreements are Bilateral and Public Agreements. Every Consumer has the right to choose to be supplied by a certain Producer under a bilateral agreement, to be supplied by a TransCo or a DisCo under a public agreement (agreement for public supply) or both. A direct telecommunication link between supplying Unit and Consumer is a prerequisite for bilateral agreements by analogy with data acquisition systems between Units and system operator.
In the case of Bilateral Agreement between a Consumer and a Producer, partners have the rights to contract specific kind and time of deliveries. In such case the Consumer makes an additional agreement with the TransCo or the DisCo for charging the positive difference between the actual consumed power and bilateral contracted one on actual nodal price at the Consumer's Node for every Single Price Period. In addition the Consumer is obliged to thc TransCo or the DisCo for transmission service fee for actual delivered power according bilateral agreement charged on the difference between actual price at Consumer's Node and price at Producer's Node for every Single Price Period. Theoretically this difference between price at the Consumer's Node and price at the Producer's Node can be negative. In such case the System Operator have to pay Allowance to the Consumer for he reduce the costs for transmission losses more than sum of network and congestion charges. This theoretical case could be included additionally to the nodal equation (1).
In the field of public agreements every time the Consumers receive power from sources as cheapest as possible. This Principle is provided by the procedure for preliminary scheduling and dispatching till the end time before every single period.
The Producers make also contracts with the System or the Distribution operators for Ancillary and System Services.
The Unit control boards serve as sites where price bids are initiated and actual production prices are confirmed both for Power and Ancillary Services. Biding is a constant process. Every hour the Unit Operators renews theirs hourly (not Single Price Period) bids for a floating day ahead. At the actual hour the Announcer check and announced periodically Single Price Periods prices.
The methods used for forming the bids, whether liberated or regulated do not affect the applicability of the proposed market model. In case of regulated method a system for revenue reconciliation have to be adopted.
The Single Price Period is very short. Technically it can be as short as 10, 15 or 30 seconds. For simplicity a regulator can sanction one minute. The preferred duration can be determined according to system's price rate response characteristics. It may seem that a precise trade system needs a uniform Single Price Period, but it may be that a variable Single Price Period could provide the same probability level for charging inaccuracy.
Supply & Charging points are located as near as possible to every conjunction point where a market participant connects to a Node. The sale of electricity is based on trade measurements and a payment agreement. Every Branch end is equipped by trade measurement tools and acts as a charging point.
Trade measurement tools are intelligent meters, which receive the price for every Single Price Period and measure the electrical energy used or transferred over that period. It than calculates the average power between two price changes and stores both the power and the price for the single period. Then the meter calculates the hourly, daily, weekly or monthly bill. These data can be stored for archive and for forecast purposes. They are available for both the Supplier and the Recipient.
Charging for power received is simple: every power Recipient pays for power delivered at his charging point at the actual price for every Single Price Period. Every single network element incurs its own expenses. At every transmission or distribution Node prices are transmuted (converted and transmitted). Separate prices are calculated for each end of every Branch. The method used for calculating Branch cost reimbursement amounts (due to Power transfers or Congestion avoidance), whether liberated or regulated, does not affect the applicability of the proposed market model. In case of regulated method a system for revenue reconciliation have to be adopted.
Ancillary Services charging is based on two prices. The first one is the price for the availability of Ancillary Services. The System Operator calculates the costs for the availability of services that he has scheduled and committed. These part of system-wide costs are allocated fairly between all participants as explained in the paragraph for Ancillary Services market below and according to equations (11) and (11a). The second price applies to activated Ancillary Services. In case the output of a Unit rises after ancillary service activation, the additional power is billed by the Node owner at the actual Unit power price to all the owners of Outlets at the Node where a Unit is connected. In case the output of a Unit drops after ancillary service activation, the difference gives rise to security constraint costs (liquidated damages) payable to the Producer; these are calculated by the System operator and then allocated fairly between all participants as explained below and according to equations (5).
As in conventional markets the Congestion forecast is a planning problem but the Congestion management according this invention become an automated process for congestion fee charging for every Single Price Period or for emergency events in order always to relieve the actual network bottlenecks. (The revenue from Congestion payments can be collected in a Fund for long-term Congestion avoidance measures). The elasticity of Market participants response to price increase in case of emergency appearance of a congestion will specify the ramp-rate of penalty function in every particular case of congestion (line, transformer, corridors, group of elements).
The System Operator must have the rights to intervene in the market situation in dangerous cases.
Transparency of price formation and access to price information is inherent in the model. The Regulator's decision whether Producers will have official information on the nodal Outlet prices or these prices will be available only to the Consumers connected to the respective Node does not affect the applicability of the proposed market model.
The impartiality of the allocation of losses and congestion fees due to physical constraints is guaranteed because the influence of each market participant on power flows, Branch losses and respective expenses receives equal consideration according physical laws. The same applies to system-wide costs for Ancillary and System Services and to security costs including liquidated damages at the time of power output reducing during AS activation. Allowances, if any, can also be included in the model for fair allocation.
All Producers or Consumers have equal transmission or distribution rights without any access charges. The Dynamic Advanced Nodal Prices implicitly include fees for access to all network elements. The allocation of Branch transfer capacity is in the end determined by the Consumers' ability to pay the respective momentary (last minute) nodal prices rather than by financial or physical Branch rights.
The balancing mechanism is based on the hitherto unknown concept of compensation costs for two types of involuntary deviations for every Single Price Period: (i) between bilaterally contracted and actual power consumed according equation (26), (ii) between dispatched and actual Unit power output according equation (27). At every Single Price Period, every Unit must compensate these two types of involuntary deviation costs for the second to last price period. This is mentioned also in the forth paragraph below and is implemented by equations (3), (4) and (5). For the sake of clearness it is worth to emphasize that we do not foresee a separated Balancing Market as it exist in the known designs.
In every EPS, a mechanism must be in place for ensuring System reliability and Market viability. This mechanism must be enacted by the regulators both at the regional and the area/block market levels. The mechanism we propose in the present invention distributes the total expenses for source adequacy and network security among final Consumers in a way as equitable as possible.
A mechanism for Market Power Mitigation is implicit in the Momentary Power Market and makes it different from existing Markets. This mechanism relies on the freedom of every Market participant and especially of Consumers to answer immediately to market price deviations and thus to react against any kind of market power form. This, however, does not remove the need for a legislative regulatory framework for monitoring and control of Market Power.
According to our invention annual or short term planning and operation process will face changes in comparison to existing practices or known proposals. Detailed explanations of expected changes in Planning or Operation Procedures caused by Momentary Power Market are beyond the aim of this invention. Here we mention only main features of these processes.
The System operators will coordinate planed outages of Units and of network elements under the terms of the improved standards for system reliability (adequacy and security). In order to provide for these standards the System operator will commit Units and network elements for power or for reserves or for Ancillary Services in due time ahead. Both Self and System Operator's scheduling are equally applicable.
At the actual day the System Operator monitors all constraints affected power system. Time and again he provides preliminary adjustment based on floating adjustment of Units' hourly bids and physical constraints forecast. (See FIG. 2 and also in the Price Rout). This is a preliminary dispatching for adjustment the bids with coming actual conditions.
Then, inside the actual hour and as close as possible before start of every Single Price Period, the System Operator designates the price and output level for every Unit (required power output or Ancillary Services inner to the operational rang) for subsequent Single Price Period and notice Units' operators for this. The Units' operators verify that these price and product demanded fit within the previously contracted constraints and in case it is so he send the confirmation back to the System Operator and set out the governor according system operator's notice. If the verification fails the Announcer substitutes the likely acceptable value and sends it to the System Operator with an error notification. At the same time Announcer sends the actual price to the nodal Transmuter at the Node to which the Unit is connected. In addition to this Unit Announcer set out compensation costs for two types of deviations: (i) between bilaterally contracted and actual power consumed, (ii) between dispatched and actual Unit power output for every Single Price Period. At every Single Price Period, every Unit must compensate these two types of involuntary deviation costs for the second to last price period.
At the same time the System operator monitors and manages network elements. In case of necessity he intervenes and makes changes in congestion fee charging functions or takes other appropriate measures.

The procedure explained in last three paragraphs is a quite automated one. It is repeating for every subsequent Single Price Period. By this and all other indispensable functions the System Operator provides System Services. The fulfilment of this procedure is confided on programmable devices named by us a Bidder, a Scheduler, a Price Designator, a price Announcer, a Price Transmuter, and an Intelligent Electric Meter. The first two devices are similar to the known art and we do not treat them. The lasts are new suggested devices. Their functions are defined in this invention.

The procedure proposed replaces known art for “real time operation” (scheduling in day ahead market following by rescheduling in the hour ahead market and than finally again re despatching in balancing/regulating market). Based on the floating forecast for the EPS' conditions in a constantly decreasing very short time horizon (reach to 5-10 seconds) the adjustment process will bring Units operation output level gradually very near to actual demand willingness according to actual operational conditions in EPS which will happen in next Single Price Period. Providers of Ancillary Services will regulate the possible smallest residual imbalance. At the time of contingency (Unit or Branch tripping) the network state changes rapidly in comparison to the forecasted. Based on the suggested procedure the prices on affected Nodes will change almost immediately at next Single Price Period. The Units and Consumers concerned are able for quickly and adequately respond to such changes. By this procedure the scheduling/dispatching process became more similar to the AGS process. The only difference is the parameter. In the case of AGC this is the Area Control Error (ACE) and it is a common for entire EPS parameter. In the case of Momentary Power Market this is the price and it is a local parameter.
The Area Control Error matter changes also because of control areas/blocks enlargement, but we consider this problem outside the scope of this invention.
Ancillary Services Market is a kind of auction market among Producers and System or Distribution operators. Expenses for reserve commitment and other Ancillary Services incur at the Node to which the provider of specific ancillary service is conjoint but are charged on all users of the services. Finally the end users have to pay equitably allocated price for Ancillary Services. That's why we propose a Principle for total expenses allocation equitably among them. We bring in such equity by assumption that this assumptive price starts at every Unit in operation and amounts to total Ancillary Services costs divided to total power output.
We propose similar Principle for equitable allocation of the system-wide costs (for System Services provided directly from System operator to all Producers and Consumers, as well as for all liquidated damages and allowances). It is implanted in formulae of Dynamic Advanced Prices. Summarizing and leaving unmentioned details we can emphasize that the System Operator's Price Designator defines the total actual sum of all system-wide costs for every Single Price Period. Then according to formulae proposed it converts expenses into generation price parts (assumptive price) and sends these prices to every Node to which at least a Unit is conjoint. Entering to the nodal Transmuter the assumptive price adds up to individual Unit costs and is converted into nodal advanced dynamic price according to nodal equation (1). Then, according to Branch equation (15), the Transmuter recalculates prices to the beginning point of each Outlet, adds up expenses for transmission and congestion fee and sends these prices to the end points of the corresponding Outlets. These end Branches prices enter into the next Node Transmuter and the process repeats until reach congruence to every Node when prices became official for the actual single period.

In order to avoid complications in this description we do not mention the process of Ancillary Services planning, bidding, scheduling, committing, and dispatching etc. because this is similar to the process applied to power described up to now. As reader is already fined out we do not consider Financial Markets and contracts nor prices and billing conditions in Bilaterally agreements because these topics are beyond the subject of our invention. At the same time we have light here sufficiently the influence of Bilaterally agreements to the rest of market participants in the frame of Momentary Power Market.

### Additional Examples

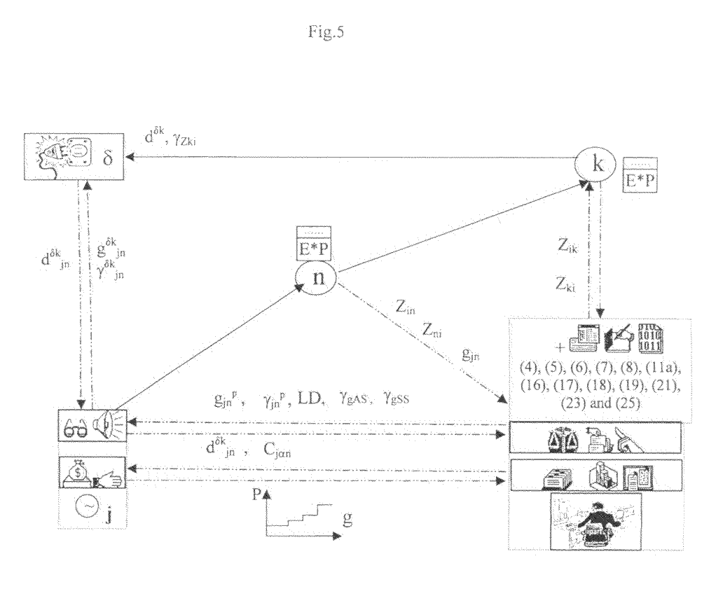

The proposed Nodal Equation and Branch Equation are universal in character, as are the applied formulae derived from them. The application of these can be realized by means of various devices and different organization types of information flows. Thus, a variant embodiment is illustrated on FIG. 5, the concept behind which is the replacement of the decentralized transmutation of prices in the Transmuters by a centralized transmutation, which is realized by extending the functions of the Price Designator. In this case, the formulae for price transmutation are programmed in the Price Designator, and a different information flow is organized, including a different route for propagating the final prices to the market participants and to every network Node.

One could, of course, list various combinations of calculation and communication devices for realizing a Momentary Power Market. The list of examples could be extended by an embodiment in which the commercially accepted means of power measurement are replaced by a subsystem for determining the network state and the distribution of power flows. Another embodiment has the Intelligent Electric Meters that measure power and register its price at the same time replaced by two separate devices. An embodiment with a missing Price Designator, however, is not recommended, since the owner of electric power ought himself to declare the price at which he sells that power.

In the final account, the competitive pressure for saving even fractions of seconds in the process of price formation and propagation ought to determine the preferred embodiment of the present invention with its set of devices and with its organization of a communication environment. Most likely, optimisation would result in a combination of a centralized and a decentralized approach, the composition of which may change in time along with the technical improvement of devices and their competitive characteristics.

### INDUSTRIAL APPLICABILITY

The deregulation of Electricity Markets worldwide is accompanied by an increased number of issues relating to the reliability (adequacy and security) of Power Systems. The resulting weakened functioning of Power Systems determines certain failures in Electricity Markets. This poor market viability leads to a number of problems, the solution for which necessitates the creation of increasingly detailed rules for the market participants. Thus, a paradox arises: after deregulation, the regulation rules become greater in number and even more complex than before. Furthermore, the rules for price formation become less transparent than under the traditional paradigm.

Thus, the greater complexity relating to reliability, as well as the known curse of the dimension and complexity of the models, could become an obstacle to the development of free energy markets.

The object of our invention is to propose avoidance of some obstacles facing free electric Power Market enlargement.

The present invention achieves this objective and others as set out in the claims enclosed. The main feature of suggested improvements is the unification of physical and market functions in a common/mutual market environment for every market participant: Producer, transmitter, distributor, Consumer, operator. We name shortly this improved power systems “Momentary Power Market” (MPM).

In accordance with the present invention such a Power Market is founded on practically possible implementation of main components of well-known advanced nodal prices [5]. We name invented prices Dynamic Advanced Prices (DAP). These prices are forming not on a model but on the actual operating EPS at the places where the expenses are incurred. The constantly updated prices start their rout at each Unit. Then they are transmitted and immediately converted trough every network element. By this prices reflect the costs for transmission and distribution of the actual active power flows. The recalculation of current prices at each Node is done based on simple formulae and reliable devices.

Our approach for prices formation and propagation replaces tremendous dynamic models and insurmountable complexity of prices determination and dissemination in the existing markets. This affords an opportunity for prices formation and propagation in a Single Price Period not longer than a few seconds. This enables Consumers and other market participants to react with the same rate as automatic generation control.

All of these can drastically change the activities of all parties to the market. Every participant can take his decision for price response and can activate his automated reaction at the very moment based on an adoptive behaviour strategy programmed in advance. The Producer will be able to react to changes in the demand, the end user—to the changes in the supply, including changes dictated by emergencies. The system operator will have qualitatively new tools to dynamically and optimally control the operations. This would be based on measured (and not modelled) values. Of course, this result could only be achieved when the current energy meters become versatile devices that are able to receive and code 1) the prices and 2) the power levels that have been used. Two separate devices rather than one could technically perform these two functions. However, we consider the first possibility to be more logical and potentially more efficient. Thus, energy meters, when equipped with an array of computer programs, could become capable of synthesizing bills, analysing and projecting data, controlling, informing and advising users, and even serving as financial intermediaries through which we can pay our bills. This is not a dream but a technological and trade challenge that can change our ideas about electricity usage very soon.

A comparison with the existing market models provides justification for the apparent boldness off these claims.

For simplicity we have discussed here mostly on a single hierarchical level of entire Interconnection (union of EPSs): Transmission System and correspondent System Operator. Occasionally we have mention Distribution level for reminding analogy. Obviously at a stage of MPM applying a system of rules has to be implemented for relationships between different hierarchical levels or neighbour EPS and their Operators or Distribution Systems and their Operators and finally for relationships between all market participants in the frame of a specific Momentary Power Market design for the entire Interconnection. The problems caused of different market rules (so cold “seam cases”) at each interface between national or area neighbour systems or between Transmission and Distribution level will seas if MPM is implemented because a common price rule for entire Interconnection will be adopted. Than one could accept our explanation enough because the matter is similar and repeated for the rest of EPS participated in the Interconnection. Thus complexity of the mater is not harmed and those of ordinary skill in the art will recognize that Momentary Power Market could function for a single EPS or for entire interconnected EPS not limited in size in all real life market different intricacy.

### Briefly, Some of the Advantages of Our Approach are Enumerated Here:

Up to now, the price of supply and demand was determined by different bodies using different procedures, but is usually known just to the market administrator. Everyone knows the closing price but no one knows the pricing of the competitors. Our method proposes that every Producer declare openly their price and this price be transmitted through the network. At the same time, the price system incorporates the price of transmission, distribution etc. into the final price. Thus, the energy could reach the end user with a marked known current price;
Up to now, the network was viewed as one distinct whole, which was owned as a Unit by one owner. There was no mechanism that could transmit the separate costs of different HV Lines, transformers and other network elements to the end users price. This hindered the recovery of expenses put into those and acted as a hindrance to private capital. Under our proposal, a mechanism that takes those into account has been devised. Each element in the network carries its price towards the end user and can be reimburse separately. This creates economic conditions that stimulate competitive private and public investors both for the production and for the network;
The need to have a specific trade environment (a power exchange, market administrator and intermediaries) is eliminated, and the whole process of supply and demand as we know it is changed;
The need for creating the most complex market—the market for balance energy—is eliminated;
The need for coming up with all kinds of rates and tariffs is eliminated (and thus the problems originating from those are resolved);
Billing and settlement are both drastically changed;
There is a legal and economic equality among all kinds of users—small-scale or large-scale, eligible or non-eligible, industrial or residential;
Congestion forecast and management are resolved solely according to market principles and the existing complex principles for allocation of market rights become unnecessary;
The problems of regional prices, cross-border distribution etc. are resolved;

At the same time we have to emphasize that the industrial implementation of Momentary Power Market cannot take place before certain problems and challenges associated with it are resolved. Broadly speaking, it is necessary to understand the balance of potential interests that could be stimulated relative to the interests that could potentially be stifled through the introduction of such a sensitive market. This suggests:
Research about the acceptance of the Momentary Power Market and the expected behaviours of Producers and Consumers;
The activation of the capabilities of the Producers and Suppliers of technical means (Designators, Announcers, Transmitters, Communicators, Intelligent Meters) and the accompanying process of licensing the trade-informational system;
Discussion and development of the methods of centralized and self scheduling and control, including the methods for optimally allocation the Unit's power output amongst bilateral and public agreements, between power and Ancillary Services; optimal decomposition and determining the functions and tasks of different natural mediators;
Development of required legal and regulatory norms and rules;
Changing of Retail services: Instead of sole electric delivery, delivery of tools for efficient Consumer behaviour;
Evolution of the methods and tools of the relatively constant, but indefinite and unstable, expenses (capital, operational, and financial) from long-lasting to momentary, as a function of the power and time.

Finally, it seems that a pilot implementation of the Momentary Power Market in the Electrical Power System of a state, or at least in a restricted part of an EPS will provide answers to most of the questions mentioned. Such a pilot project would build experience and would indicate the correct way to proceed with the global implementation of the Momentary Power Market.

### CONCLUSIONS

What was said so far does not in any way suggest we are taking sides on the advantages and disadvantages of the liberalization of the Electricity Markets. As we consider the liberalization inevitable, it is best that it unfold with the least possible negative impact on social development. This is why we created and described the foundations of Momentary Power Market. Initially it may create negative feelings, disturbance or shock. We hope that after this initial reaction is overcome, our proposal would contribute to social welfare.

### REFERENCES

[1] R. E. Bohn, M. C. Karamanis, and F. C. Schweppe, OPTIMAL PRICING IN ELECTRIC NETWORKS OVER SPACE AND TIME, Rand Jurnal of Economics, Vol. 15, Autumn 1984;
[2] Schweppe Fred, Caramanis Michael, Tabors Richard and Bohn Roger, SPOT PRICING OF ELECTRICITY, Kluwer Academic Publishers, Boston, Mass., 1988;
[3] R. J. Kaye, F. F. Wu, and P. Waraiya, PRICING FOR SYSTEMS SECURITY, IEEE Transactions on Power Systems, Vol. 10, May 1995;
[4] G. B. Sheble, PRICE BASED OPERATION IN AN AUCTION MARKET STRUCTURE, IEEE Transactions on Power Systems, vol. 11, no. 4, pp. 1770-1777, November 1996;
[5] Martin L. Baughman, Shams N. Siddiqi, Jan W. Zarnikau, ADVANCED PRICING IN ELECTRICAL SYSTEMS, Part I: Theory and Part II: Implication, IEEE Trans. on Power Systems, Vol. 12, No. 1, Feb. 1997;
[6] Kai Xie, Yong-Hua Song, John Stonham, Erkeng Yu, and Guangyi Liu, DECOMPOSITION MODEL AND INTERIOR POINT METHODS FOR OPTIMAL SPOT PRICING OF ELECTRICITY IN DEREGULATION ENVIRONMENTS, IEEE Transactions on Power Systems, Vol. 15, February 2000;
[7] PRICING IN COMPETITIVE ELECTRICITY MARKETS, edited by Ahmad Faruqui and Kelly Eakin, Kluwer Academic Publishers, 2000;
[8] Afzal S. Siddiqui, Chris Marnay; and Mark Khavkin, SPOT PRICING OF ELECTRICITY AND ANCILLARY SERVICES IN COMPETITIVE CALIFORNIA MARKET, Proceedings of the 34 Hawaii International Conference on System Sciences, January, 2001;
[9] L. Chen, H. Suzuki, T. Wachi, and Y. Shimura, COMPONENTS OF NODAL PRICING FOR ELECTRIC POWER SYSTEMS, IEEE Transactions on Power Systems, Vol. 17, February 2002;
[10] C. W. Yu, A. K. David, The Hong Kong Polytechnic University, Kowloon, Hong Kong; PRICING TRANSMISSION SERVICES IN THE CONTEXT OF INDUSTRY DEREGULATION, IEEE Transactions on Power Systems, Vol. 12, No. 1, February 1997;
[11] A. K David, DISPATCH METHODOLOGIES FOR OPEN ACCESS TRANSMISSION SYSTEM, IEEE, TPS, 13, 1, 1998;
[12] Dariush Shirmohammadi, Bruce Wollenberg, Ali Vojdani, Patrick Sandrin, Mario Pereira, Farrokh Rahimi, Tom Schneder, Brian Stott, TRANSMISSION DISPATCH AND CONGESTION MANAGEMENT (TDCM) IN THE EMERGING ENERGY MARKET STRUCTURES, IEEE Trans. on PS, Vol. 13, No 4, Nov. 1998;
[13] Xing Wang, Yong-Hua Song and Qiang Lu, A COORDINATED REAL-TIME OPTIMAL DISPATCH METHOD FOR UNBUNDLED ELECTRICITY MARKET, IEEE Transactions on Power Systems, Vol. 17, No 2, May 2002;
[14] Fernando Alvarado, THE STABILITY OF POWER SYSTEM MARKETS, IEEE Transactions on Power Systems, Vol. 14, No 2, May 1999, pp. 505-511;
[15] Daoyuang Zhang, Yajun Wang, and Peter B. Luh, OPTIMIZATION BASED BIDDING STRATEGIES IN THE DEREGULATED MARKET, IEEE Transactions on Power Systems, Vol. 15, No. 3, August 2000;
[16] Haili Song, Chen-Chung Liu, Jacques Lawarree, and Robert W. Dahlgren, OPTIMAL ELECTRICITY SUPPLY BIDDING BY MARKOV DECISION PROCESS, IEEE Transactions on Power Systems , vol. 15, No 2, May 2000;
[17] J. M. Aroyo, and A. J. Conejo, OPTIMAL RESPONSE OF A THERMAL UNIT TO AN ELECTRICITY SPOT MARKET, IEEE Transactions on Power Systems, Vol. 15, No 3, August 2000;
[18] Meadhbh E. Flymi, MichaelI P. Walsh, and Mark J. O'Malley, EFFICIENCY USE OF GENERATOR RESOURCES IN EMERGING ELECTRICITY MARKETS, IEEE Transactions on Power Systems, Vol. 15, No 1, February 2000;
[19] Maree A. Bolton, David J. Hill, and Robert Kaye, DESIGNING ANCILLARY SERVICES MARKETS FOR POWER SYSTEM SECURITY, IEEE Transactions on Power Systems, Vol. 15, No 2, May 2000;
[20] E. Hirst, B. Kiby, ANCILARY SERVISIES, Oakn Ridge National Laboratory, Technical report ORNL/CON 310, February 1996;
[21] Tomas Gomes, Chris Mamay, Afzal Siddiqui, and Mark Khavkin, ANCILARY SERVISIES MARKETS IN CALIFORNIA, LBNL-43986, July 1999;
[22] G. Hamoud, FEASIBILITY ASSESSMENT OF SIMULTANEOUS BILATERAL TRANSACTIONS IN DEREGULATED ENVIRONMENT, IEEE Transactions on Power Systems, Vol. 15, February 2000;
[23] Balhom H. Kim and Ross Baldick, A COMPARISON OF DISTRIBUTED OPTIMAL POWER FLOW ALGORITHMES, IEEE Transactions on Power Systems, Vol. 15, May 2000;
[24] F. D. Galiana, I. Kockar, and C. Franco, COMBINED POOL/BILATERAL DISPATCH-PART 1; PERFORMANCE OF TRADING STRATEGIES, IEEE Transactions on Power Systems, Vol. 17, February 2002;
[25] F. D. Galiana, I. Kockar, and C. Franco, COMBINED POOL/BILATERAL DISPATCH-PART II; CURTAILMENT of FIRM and NONFIRM CONTRACTS, IEEE Transactions on Power Systems, Vol. 17, November 2002;
[26] F. D. Galiana, I. Kockar, and C. Franco, COMBINED POOL/BILATERAL DISPATCH-PART III; UNBUNDLING COSTS of TRADING SERVICES, IEEE Transactions on Power Systems, Vol. 17, November 2002;
[27] Tomoaki Nakashima, and Tak Nimura, MARKET PLURALITY AND MANIPULATION: PERFORMANCE COMPARISON OF INDEPENDENT SYSTEM OPERATORS, IEEE Transactions on Power Systems, Vol. 17, No 3, August 2002;
[28] Robert Wilson, NONLINEAR PRICING, Oxford University Press, 1993;
[29] Editors: Benjamin F. Hobbs, Michael H. Rothkopf, Richard P. O'Neill, Hung-po Chao, THE NEXT GENERATION OF ELECTRIC POWER UNIT COMMITMENT MODEL, Kluwer Academic Publishers;

[30] WO03025817
[31] US2002046155
[32] WO9958987
[33] WO9923455
[34] WO03005599
[35] 20030220864 A1
[36] 20030229576 A1
[37] 20030041038 A1
[38] 20030041002 A1
[39] 20030055776 A1

What is claimed is:

1. An complex electric power system unlimited in size, but with a finite number of generation units, grid elements, consumers, national or regional districts, and distribution networks, enabling each consumer to receive electricity and real time prices simultaneously, which system is characterized by the following additional equipments installed for efficient control end secure supply of electricity: —a Bidder, installed at the control room of each generation unit, enabling to submit to the system operator bids for suggested power and prices, and also information for contracted power and prices, for each hour in a continuous rolled horizon; —a Scheduler and Price Designator installed at the control board of the system operator by which he determines the dispatched amount of power or ancillary services and the prices, that are to be realized on every generation unit over the next single price period, and by which he notifies the operators of generation units; —a Price Announcer installed at the control room of each generation units enabling constant labelling of price to the power generated according to the products dispatched to the unit, and to transmit the labels to the grid nods by which the generation unit is connected; —a Price “Transmuter” installed at each grid node enabling to determine the surcharges due to possible congestion or network security limitations, to add such charges to the received generation prices and to transmit the result to every neighbour node along with the branch charges added; —an Intelligent Electric Meter installed at each grid branch and consumer outlet, consisting of metering device, power controller and means for receiving, recording and forecasting of the price, enabling the consumer to receive power and resulting price simultaneously for automatic control of his demand during every Single Price Period, several seconds or minutes long, into a continuous cyclically repeated process.

2. A system according to claim 1 characterized by that the system dispatch control is further improved by the substitution of the real-time or balancing market by the mandatory process for each generation unit to compensate over every subsequent single price period for the costs of involuntary deviations over the preceding single-price period for the differences: i) between power bilaterally contracted by the unit and power actually consumed by its partners and ii) that between power dispatched and power actually provided by the unit.

3. A system according to claim 1, where the system dispatch control improvement comprises integration of the Congestion Management with Whole sale and Retail Markets through the combination of the Bilateral Contract Market, the Multilateral Contract Market and the Ancillary Service Market, along with System services, into a continuous cyclically repeated process of preparation, formation, transmutation, and propagation of a price for every location where electric power or network components change ownership, which price corresponds to the actually produced, transported, distributed and delivered amount of power during every Single Price Period within the security limits in technical characteristics of every generating unit end network element.

4. (canceled)

5. (canceled)

6. A System according to claim 1 in which the functions of the Price Transmuters are taken over by the Price Designator, and the organization of information flows and the communication environment are rearranged.

7. A System according to claim 1 or 6 characterized by the division of the functions of the Intelligent Electric Meters between different devices: a conventional electric meter, a power controller, a price receiver, a price recorder, and a price forecaster.

8. A System according to claim 7 characterized by the substitution for the Conventional electric meters of a special System of tele-measurement and integration of momentary power flows in combination with a Detection System for the State of the Network.

9. A System according to claim 3 characterized by the selective execution of the process of continuous preparation, formation, transmutation, and propagation of the prices by a heterogeneous combination of devices for centralized and decentralized transmutation and propagation, so that partial realizations of systems according to claims 6, 7, or 8 are realized within a common power system.

10. A Method for the dispatch control of a complex electric power systems by which the real-time dispatching procedures are improved by an automatic process for the cyclically repeated formation and propagation of the dispatch notices based on price for every single price period (several seconds or minutes long), during which the system operator determines the dispatched power and the corresponding price for the coming single price period, then by means of price announcer the operator of the generation unit verifies the received dispatcher's task, adjusts the unit governor, and sends the labelled power along with compensation amounts to the grid node where the unit is connected, so that the iterated transmutation of the price for the current single price period occur and the price be made official for the purpose of automatic power control and settlement simultaneously.
